(19) United States
(12) Patent Application Publication
(10) Pub. No.: US 2026/0183858 A1
(43) Pub. Date: Jul. 2, 2026

(54) ARC WELDING METHOD AND ARC WELDING APPARATUS

(71) Applicant: Panasonic Intellectual Property Management Co., Ltd., Osaka (JP)

(72) Inventors: Masashi FUJIWARA, Osaka (JP); Junji FUJIWARA, Osaka (JP); Kazuki KASANO, Osaka (JP); Noriyuki MATSUOKA, Osaka (JP); Tatsuyuki NAKAGAWA, Osaka (JP)

(21) Appl. No.: 19/551,083

(22) Filed: Feb. 26, 2026

Related U.S. Application Data
(63) Continuation of application No. PCT/JP2024/030256, filed on Aug. 26, 2024.

(30) Foreign Application Priority Data
Sep. 1, 2023 (JP) 2023-142424

(51) Int. Cl. B23K 9/09; B23K 9/095; B23K 9/173

(52) U.S. Cl. CPC B23K 9/09; B23K 9/095; B23K 9/173

(57) ABSTRACT

An arc welding method of a consumable electrode type performs welding while supplying a welding current I between a workpiece W and a welding wire 13 to generate an arc A and supplying a shielding gas S around the arc A. An arc length L represented by a relative position of a tip end 13a of the welding wire 13 with respect to a surface Wa of the workpiece W is within 2 mm. The shielding gas S is constituted of 100% argon. The welding current I is constituted of a pulse wave in which a base current IB and a peak current IP are periodically and alternately repeated. An average current IA per cycle of the welding current I is 250 A or more. The base current IB is 200 A or more. The peak current IP is 600 A or less.

### CROSS-REFERENCE TO RELATED APPLICATIONS

This is a continuation of International Application No. PCT/JP2024/030256 filed on Aug. 26, 2024, which claims priority to Japanese Patent Application No. 2023-142424 filed on Sep. 1, 2023. The entire disclosures of these applications are incorporated by reference herein.

### TECHNICAL FIELD

The present disclosure relates to consumable electrode type arc welding method and arc welding apparatus.

### BACKGROUND ART

In arc welding, welding is generally performed while supplying a welding current between an object to be welded and an electrode to generate an arc and supplying a shielding gas around the arc. For example, argon is used as the shielding gas. The welding current is constituted of a pulse wave in which a base current and a peak current are periodically and alternately repeated.

In arc welding, when deep penetration into the object to be welded is desired, it is a possible option to simply increase an average current per cycle (set current) of the welding current. However, when the average current is simply increased, a welding defect, such as smut, puckering, or the like, occurs.

In an arc welding method according to Japanese Unexamined Patent Publication No. 2003-019564, a mixture of argon and helium is used as a shielding gas.

### SUMMARY

### Technical Problem

In the arc welding method described in Japanese Unexamined Patent Publication No. 2003-019564, by mixing helium with argon in the shielding gas, a welding defect, such as smut, puckering, or the like, is suppressed and concentration of arc is increased to achieve deep penetration.

However, in recent years, it is difficult to obtain helium for a reason of a sharp rise in helium price or the like, and it is challenging to produce a shielding gas constituted of a mixture of argon and helium as described in Japanese Unexamined Patent Publication No. 2003-019564.

Moreover, although there is a method in which oxygen of approximately 1% is mixed with argon in a shielding gas, in this method, a bead surface is oxidized to turn black or smut adheres, so that an appearance of a bead is spoiled.

In view of the foregoing, the present disclosure has been devised and it is therefore an object of the present disclosure to achieve, for arc welding, deep penetration, while suppressing a welding defect even when 100% argon is used as a shielding gas.

### Solution to the Problem

An arc welding method according to the present disclosure is an arc welding method of a consumable electrode type in which welding is performed while supplying a welding current between an object to be welded and an electrode that is a welding wire to generate an arc and supplying a shielding gas around the arc, an arc length represented by a relative position of a tip end of the electrode with respect to a surface of the object to be welded is within ±2 mm, the shielding gas is constituted of 100% argon, the welding current is constituted of a pulse wave in which a base current and a peak current are periodically and alternately repeated, an average current per cycle of the welding current is 250 A or more, the base current is 200 A or more, and the peak current is 600 A or less.

An arc welding apparatus according to the present disclosure is an arc welding apparatus of a consumable electrode type that performs welding while supplying a welding current between an object to be welded and an electrode that is a welding wire to generate an arc and supplying a shielding gas around the arc, an arc length represented by a relative position of a tip end of the electrode with respect to a surface of the object to be welded is within ±2 mm, the shielding gas is constituted of 100% argon, the welding current is constituted of a pulse wave in which a base current and a peak current are periodically and alternately repeated, an average current per cycle of the welding current is 250 A or more, the base current is 200 A or more, and the peak current is 600 A or less.

### Advantages of the Invention

According to the present disclosure, for arc welding, deep penetration can be achieved while suppressing a welding defect even when 100% argon is used as shielding gas.

### BRIEF DESCRIPTION OF THE DRAWINGS

FIG. 1 illustrates an arc welding apparatus.

FIG. 2 illustrates an arc length.

FIG. 3 illustrates a penetration depth.

FIG. 4 illustrates change of a welding current with time.

FIG. 5 illustrates a first working example.

FIG. 6 illustrates a second working example.

FIG. 7 illustrates a third working example.

### DETAILED DESCRIPTION

Embodiments of the present disclosure will be described in detail below with reference to the accompanying drawings. The following description of preferred embodiments describes mere examples by nature and is not intended to limit the scope, application, or use of the present disclosure.

### (Arc Welding Apparatus)

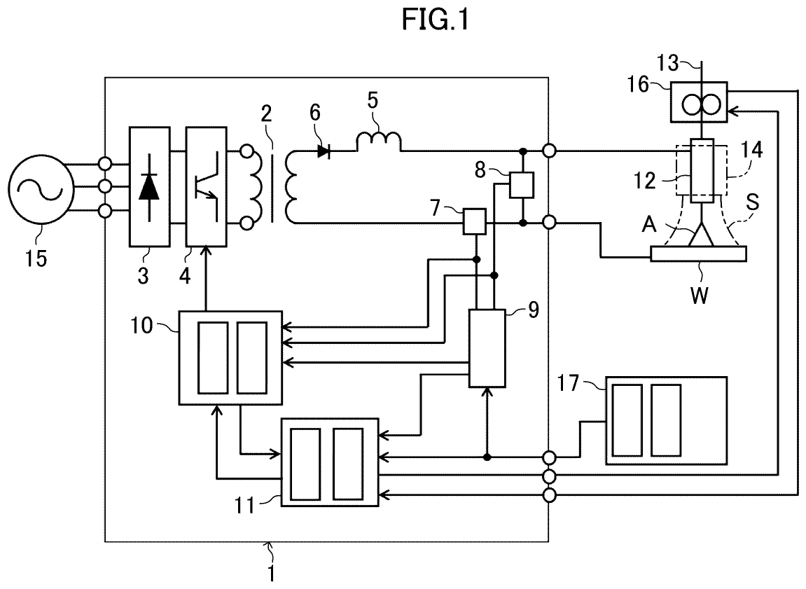

An arc welding method will be described. The arc welding method is performed by an arc welding apparatus 1. The arc welding method and the arc welding apparatus 1 are of a consumable electrode type. FIG. 1 illustrates the arc welding apparatus 1.

The arc welding apparatus 1 performs the arc welding method. In the arc welding method, welding is performed while supplying a welding current I between a workpiece W that is an object to be welded and a welding wire 13 that serves as an electrode to generate an arc A and supplying a shielding gas S around the arc A. The workpiece W is a metal. The electrode is the welding wire 13. In this example, the arc welding apparatus 1 performs metal inert gas (MIG) welding.

The arc A is generated between the workpiece W and the welding wire 13. The welding wire (electrode wire) 13 is a metal as a filler material used in arc welding. The welding wire 13 is held in a torch (not illustrated). As the torch moves at a predetermined speed, the welding wire 13 similarly moves on a weld line in a welding direction at the same speed along a predetermined welding section.

The arc welding apparatus 1 includes a main transformer 2, a primary rectifying portion 3, a switching portion 4, a DCL (reactor) 5, a secondary rectifying portion 6, a welding current detecting portion 7, a welding voltage detecting portion 8, a control switching portion 9, an output control portion 10, a wire feeding speed control portion 11, a welding tip 12, the welding wire 13, a nozzle 14, a wire feeding portion 16, and a welding condition setting portion 17. The arc welding apparatus 1 includes a robot control portion (not illustrated) that controls an operation of a robot (not illustrated) holding the torch (not illustrated).

The primary rectifying portion 3 rectifies an input voltage input from an input power source (three-phase AC power source) 15 provided outside the arc welding apparatus 1. The switching portion 4 controls an output of the primary rectifying portion 3 to an output suitable for welding. The main transformer 2 converts an output of the switching portion 4 to an output suitable for welding.

The secondary rectifying portion 6 rectifies an output of the main transformer 2. The DCL (reactor) 5 smooths an output of the secondary rectifying portion 6 to a current suitable for welding. The welding current detecting portion 7 detects a welding current I flowing through the welding wire 13. The welding voltage detecting portion 8 detects a welding voltage applied between the welding wire 13 and the workpiece W.

The control switching portion 9, the output control portion 10, the wire feeding speed control portion 11, and the welding condition setting portion 17 are each constituted of one or more central processing units (CPUs) or one or more micro control units (MCUs) and are each also referred to as a controller.

The control switching portion 9 outputs a signal to the output control portion 10 to make switching to short-circuit welding control or pulse welding control, based on determination on whether a short-circuit state or an arc state exists by the welding voltage detecting portion 8.

The wire feeding portion 16 feeds the welding wire 13 toward the workpiece W. The wire feeding speed control portion 11 controls a feeding speed of the welding wire 13. The welding condition setting portion 17 sets welding conditions.

The output control portion 10 outputs a control signal to the switching portion 4 to control a welding output. The output control portion 10 controls the welding current I to achieve an average current IA. The output control portion 10 sets the welding current I to the average current IA. The average current IA is also called set current. The average current IA is a moving average value of the welding current I during a predetermined period. Specifically, the average current IA is an average value per cycle T of the pulsed welding current I that will be described later.

The arc welding apparatus 1 supplies the welding current I to the welding wire 13 via the welding tip 12. The arc welding apparatus 1 supplies the welding current I between the workpiece W and the welding wire 13 to generate the arc A.

The nozzle 14 surrounds the welding tip 12. A shielding gas S supplied from a shielding gas supply portion (not illustrated) flows between the nozzle 14 and the welding tip 12 and is blown toward the workpiece W. Thus, the shielding gas S is supplied around the arc A. As will be described in detail later, the shielding gas S is formed of 100% argon.

As described above, the arc welding apparatus 1 (arc welding method) performs welding while supplying the welding current I between the workpiece W and the welding wire 13 to generate the arc A and supplying the shielding gas S around the arc A.

### (Arc Length)

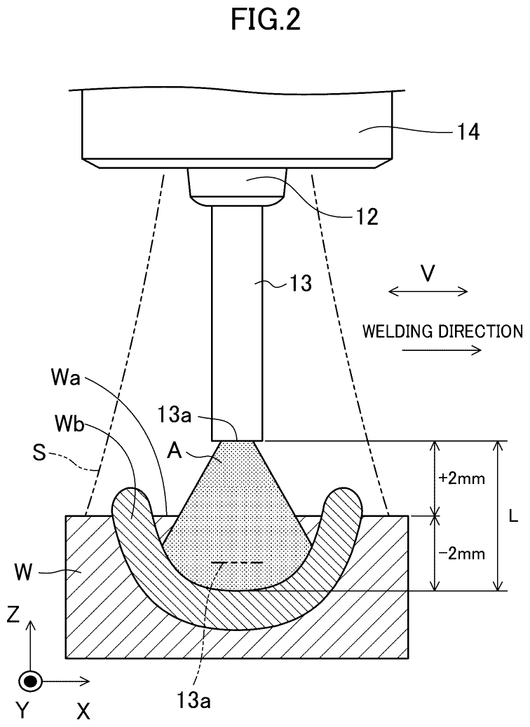

FIG. 2 illustrates an arc length L, The arc length L is a distance between both ends of the arc, specifically between a tip end 13a of the welding wire 13 and a surface Wa of the workpiece W, when arc welding is performed. In this example, the arc length L is represented by a relative position of the tip end 13a of the welding wire 13 with respect to the surface Wa of the workpiece W. An inner side of the workpiece W with respect to the surface Wa of the workpiece W (a lower side in FIG. 2, an opposite side to the welding tip 12) is defined as negative and an opposite side to the inner side with respect to the surface Wa of the workpiece W (an upper side in FIG. 2, a welding tip 12 side) is defined as positive.

When the arc length L is negative (see a thick two-dot chain line), the tip end 13a of the welding wire 13 is submerged (buried) into an interior of the workpiece W, and submerged arc welding is performed. When the arc length L is positive, welding is performed in a state where the tip end 13a of the welding wire 13 and the workpiece W are separated from each other.

The workpiece W and the welding wire 13 are melted by heat of the arc A, so that a molten pool Wb is formed. An electrode that is the welding wire 13 is fed toward the workpiece W.

The arc length L is within ±2 mm with respect to the surface Wa of the workpiece W.

Note that the welding wire 13 moves at a moving speed V in a direction in which the surface Wa of the workpiece W extends.

### (Penetration Depth)

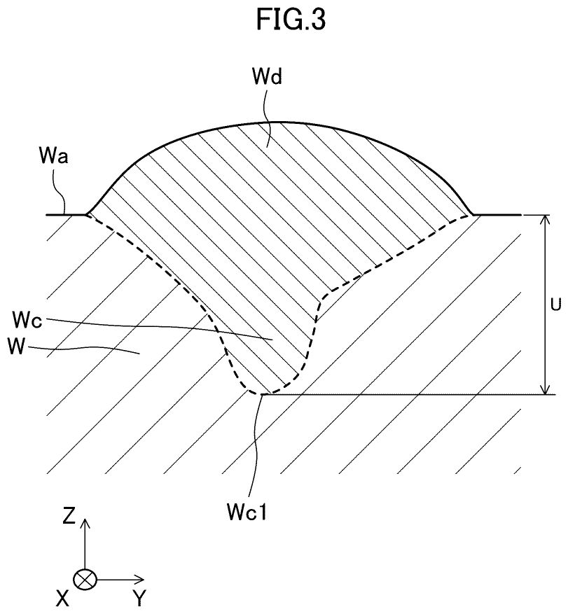

FIG. 3 illustrates a cross section of a weld bead in a width direction, illustrating a penetration depth (penetration amount) U. The penetration depth U is represented by a distance between an apex (lower end) Wcl of a molten portion We that is a portion melted by welding in the workpiece W and the surface Wa of the workpiece W. The weld bead Wd is formed on the surface Wa of the workpiece W so as to be raised therefrom.

### (Welding Current)

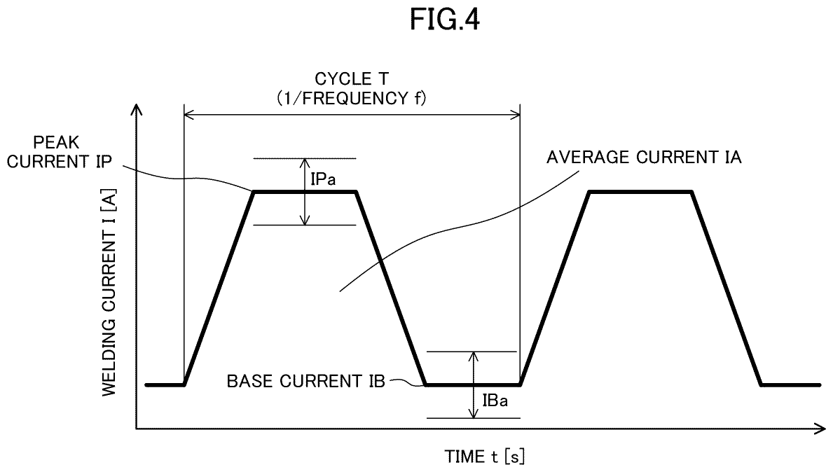

FIG. 4 illustrates change of the welding current I with time by a graph. An abscissa represents time t [s]. An ordinate represents the welding current I [A]. The welding current I is constituted of a pulsed wave where a base current IB and a peak current IP are periodically and alternately repeated. A value of the peak current IP is larger than a value of the base current IB. In the welding current I, the base current IB is a trough and the peak current IP is a crest.

The base current IB may have a predetermined fluctuation width IBa. The peak current IP may have a predetermined fluctuation width IPa.

As described above, the average current IA is the average value per cycle T of the pulsed welding current I. The period T [s] is a reciprocal of a frequency f [Hz](T=1/f).

The average current IA can be maintained constant by adjusting a difference between the base current TB and the peak current JP and the frequency f. Specifically, in order to maintain the average current IA constant, the peak current IP may be reduced when the base current IB increases and the peak current IP may be increased when the base current IB reduces. Depending on cases, it is necessary to adjust the frequency f in order to maintain the average current IA constant.

### (Welding Conditions)

The welding conditions will be described.

As described above, the arc length L is within ±2 mm with respect to the surface Wa of the workpiece W.

As described above, the shielding gas S is constituted of 100% argon. The shielding gas S does not contain any element other than argon (for example, helium, oxygen, carbon dioxide, or the like).

The average current IA is 250 A or more. The base current IB is 200 A or more. The peak current IP is 600 A or less.

When the average current IA is around 300 A (preferably, when the average current IA is constant at 300 A), it is preferable that the base current IB is 200 A or more (preferably, 220 A or more) and 300 A or less and the peak current IP is 300 A or more and 500 A or less.

When the average current IA is around 400 A (preferably, when the average current IA is constant at 400 A), it is preferable that the base current TB is 200 A or more and 400 A or less and the peak current IP is 400 A or more and 600 A or less.

When the average current IA is around 500 A (preferably, when the average current IA is constant at 500 A), it is preferable that the base current IB is preferably 400 A or more and 500 A or less and the peak current TP is preferably 500 A or more and 600 A or less.

Herein, the term “smut” refers to a fine metal oxide generated since some of molten droplets are evaporated at the tip end of the welding wire 13 by are heat, are displaced from a shielded region that is shielded by the shielding gas S, disperse outside the shielded region, are oxidized, and are solidified. The term “puckering” refers to a phenomenon where, when an effect of the shielding gas is insufficient, for example, when displacement from the shielding region occurs, atmosphere (outside air) is drawn in from periphery of the molten pool, and a thick, wrinkled oxide layer is generated on a surface of the weld bead, so that a defective bead resembling elephant skin is formed.

### First Working Example

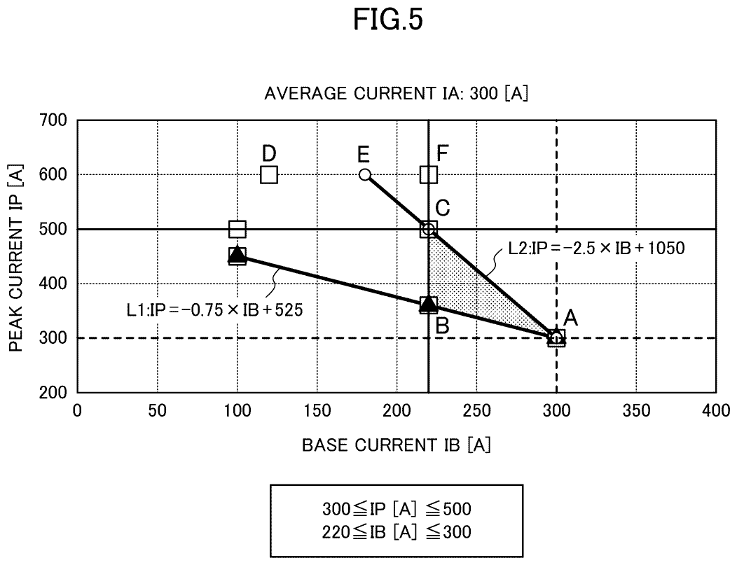

A first working example will be described. Table 1 and FIG. 5 illustrate the first working example.

In the first working example, the average current IA was set to approximately 300 A. Specifically, in the first working example, the average current IA was set to be constant at 300 A.

In the first working example, a welding speed (a speed at which the welding wire 13 moves in the direction (welding direction) in which the workpiece surface Wa of the workpiece W extends, see FIG. 2) V was set to 40 cm/min. A plate thickness of the workpiece W was set to 10 mm. A material of the workpiece W and a material of the welding wire 13 as the electrode were constituted of aluminum or an alloy containing aluminum as a main component. A torch advance angle (when the plate thicknesses was 8 mm or more and less than 12 mm) was set to 15 degrees.

A pass criterion was that the arc length L was within ±2 mm with respect to the workpiece surface Wa and a fail criterion was that the arc length L was larger than ±2 mm or less than −2 mm. Another pass criterion was that the penetration depth U was 50% or more of the plate thickness (in the first working example, 10 mm×0.5=5 mm or more) and all other cases were determined as fail. An appearance of the weld bead Wd was visually examined and thus was evaluated. In visual examination, a case where a welding defect, such as smut, puckering, or the like, was not visibly recognized was determined as pass and a case where these defects were visibly recognized were determined as fail.

As illustrated in Table 1 and FIG. 5, in the first working example, favorable results were obtained under condition numbered A through C.

As illustrated in FIG. 5, the base current IB [A] is plotted on an abscissa that is one axis of an orthogonal coordinate system. The peak current IP [A] is plotted on an ordinate that is the other axis of the orthogonal coordinate system. The base current IB and the peak current IP (the welding current I) when the favorable results were obtained belong to a region sandwiched between a first straight line L1 and a second straight line L2 that represent a relationship between the base current IB and the peak current IP.

In this example, the first straight line L1 and the second straight line L2 are linear functions. As for the first straight line L1 and the second straight line L2, one of the base current IB and the peak current IP is a function of the other. As for the first straight line L1 and the second straight line L2, the base current IB is a function of the peak current IP and the peak current IP is a function of the base current TB.

The conditions under which the favorable results were obtained in the first working example are as follows, as illustrated in FIG. 5. The base current IB is 220 A or more and 300 A or less. The peak current IP is 300 A or more and 500 A or less. The first straight line L1 is represented by IP=−0.75×IB+525. The second straight line L2 is represented by IP=−2.5×TB+1050.

TABLE 1

| CONDITION | | | | | | |
|---|---|---|---|---|---|---|
| NUMBER | | | | | | |
| (AVERAGE | BASE | PEAK | | | PENTRATION | |
| CURRENT | CURRNET | CURRNET | FREQUENCY | ARC LENGTH | DEPTH | |
| IA: 300A) | IB [A] | IP [A] | F [HZ] | L [mm] | U [mm] | APPEARANCE |
| A | 300 | 300 | — | ∘ + 1 | ∘ 6.0 | ∘ GOOD |
| | | | | | | APPEARANCE |
| B | 220 | 360 | 280 | ∘ + 1 | ∘ 6.2 | ∘ GOOD |
| | | | | | | APPEARANCE |
| C | 220 | 500 | 140 | ∘ + 3 | ∘ 6.8 | ∘ GOOD |
| | | | | | | APPEARANCE |
| D | 120 | 600 | 200 | x + 5 | ∘ 8.5 | x SMUT |
| E | 180 | 600 | 150 | x | x | x |
| | | | | UNMEASURABLE | UNMEASURABLE | PUCKERING |
| F | 220 | 600 | 100 | x + 3 | ∘ 7.0 | x SMUT |

### Second Working Example

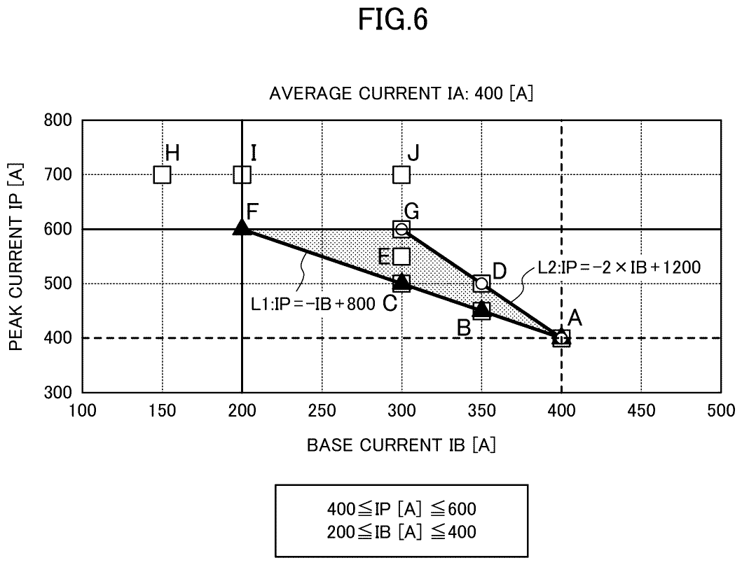

The second working example will be described. Table 2 and FIG. 6 illustrate the second working example.

In the second working example, the average current IA was set to approximately 400 A. Specifically, in the second working example, the average current IA was set to be constant at 400 A.

In the second working example, the welding speed V was set to 40 cm/min. The plate thickness of the workpiece W was set to 15 mm. The material of the workpiece W and the material of the welding wire 13 as the electrode were constituted of aluminum or an alloy containing aluminum as a main component. The torch advance angle (when the plate thicknesses was 12 mm or more and less than 18 mm) was set to 15 degrees. A case where the penetration depth U was 50% or more of the plate thickness (in the second working example, 15 mm×0.5=7.5 mm or more) was determined as pass. Other conditions were similar to those in the first working example.

As illustrated in Table 2 and FIG. 6, in the first working example, favorable results were obtained under condition numbered A through G.

The conditions when the favorable results in the second working example were obtained are as follows, as illustrated in FIG. 6. The base current IB is 200 A or more and 400 A or less. The peak current IP is 400 A or more and 600 A or less. The first straight line L1 is represented by IP=−IB+800. The second straight line L2 is represented by IP=−2×IB+1200.

TABLE 2

| CONDITION | | | | | | |
|---|---|---|---|---|---|---|
| NUMBER | | | | | | |
| (AVERAGE | BASE | PEAK | | | PENTRATION | |
| CURRENT | CURRNET | CURRNET | FREQUENCY | ARC LENGTH | DEPTH | |
| IA: 400A) | IB [A] | IP [A] | f [HZ] | L [mm] | U [mm] | APPEARANCE |
| A | 400 | 400 | — | ∘ + 1 | ∘ 11.1 | ∘ GOOD |
| | | | | | | APPEARANCE |
| B | 350 | 450 | 262 | ∘ + 1 | ∘ 11.1 | ∘ GOOD |
| | | | | | | APPEARANCE |
| C | 300 | 500 | 320 | ∘ + 2 | ∘ 11.8 | ∘ GOOD |
| | | | | | | APPEARANCE |
| D | 350 | 500 | 200 | ∘ + 2 | ∘ 11.1 | ∘ GOOD |
| | | | | | | APPEARANCE |
| E | 300 | 550 | 250 | ∘ + 2 | ∘ 11.6 | ∘ GOOD |
| | | | | | | APPEARANCE |
| F | 200 | 600 | 320 | ∘ + 2 | ∘ 12.7 | ∘ GOOD |
| | | | | | | APPEARANCE |
| G | 300 | 600 | 200 | ∘ + 2 | ∘ 11.9 | ∘ GOOD |
| | | | | | | APPEARANCE |
| H | 150 | 700 | 310 | x | x | x |
| | | | | UNMEASURABLE | UNMEASURABLE | PUCKERING |
| I | 200 | 700 | 265 | x | x | x |
| | | | | UNMEASURABLE | UNMEASURABLE | PUCKERING |
| J | 300 | 700 | 160 | x | x | x |
| | | | | UNMEASURABLE | UNMEASURABLE | PUCKERING |

### Third Working Example

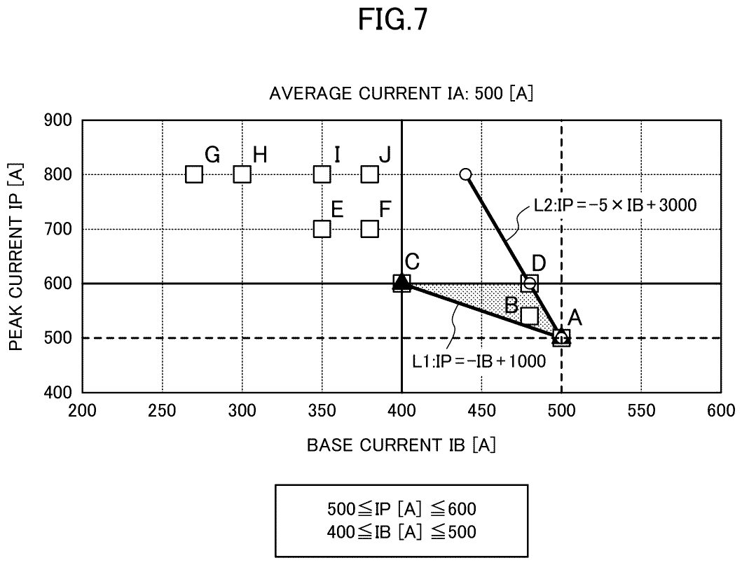

A third working example will be described. Table 3 and FIG. 7 illustrate the third working example.

In the third working example, the average current IA was set to approximately 500 A. Specifically, in the third working example, the average current IA was set to be constant at 500 A.

In the third working example, the welding speed V was set to 40 cm/min. The plate thickness of the workpiece W was set to 20 mm. The material of the workpiece W and the material of the welding wire 13 as the electrode were constituted of aluminum or an alloy containing aluminum as a main component. The torch advance angle (when the plate thicknesses was 18 mm or more and less than 25 mm) was set to 15 degrees. A case where the penetration depth U was 50% or more of the plate thickness (in the third working example, 20 mm×0.5=10 mm or more) was determined as pass. Other conditions were similar to those in the first and second working examples.

As illustrated in Table 3 and FIG. 7, in the third working example, favorable results were obtained under conditions numbered A through D.

The conditions under which the favorable results were obtained in the third working example are as follows, as illustrated in FIG. 7. The base current IB is 400 A or more and 500 A or less. The peak current IP is 500 A or more and 600 A or less. The first straight line L1 is represented by IP=−IB+1000. The second straight line L2 is represented by IP=5×IB+3000.

TABLE 3

| CONDITION | | | | | | |
|---|---|---|---|---|---|---|
| NUMBER | | | | | | |
| (AVERAGE | BASE | PEAK | | ARC | PENTRATION | |
| CURRENT | CURRNET | CURRNET | FREQUENCY | LENGTH | DEPTH | |
| IA: 500A) | IB [A] | IP [A] | F [HZ] | L [mm] | U [mm] | APPEARANCE |
| A | 500 | 500 | — | ∘ ± 0 | ∘ 15.3 | ∘ GOOD |
| | | | | | | APPEARANCE |
| B | 480 | 540 | 250 | ∘ ± 0 | ∘ 15.9 | ∘ GOOD |
| | | | | | | APPEARANCE |
| C | 400 | 600 | 300 | ∘ ± 0 | ∘ 16.5 | ∘ GOOD |
| | | | | | | APPEARANCE |
| D | 480 | 600 | 100 | ∘ ± 0 | ∘ 16.0 | ∘ GOOD |
| | | | | | | APPEARANCE |
| E | 350 | 700 | 250 | ∘ ± 0 | x | x POOR |
| | | | | | UNMEASURABLE | APPEARANCE |
| F | 380 | 700 | 230 | ∘ ± 0 | x | x POOR |
| | | | | | UNMEASURABLE | APPEARANCE |
| G | 270 | 800 | 260 | x + 5 | x | x PUCKERING |
| | | | | | UNMEASURABLE | |
| H | 300 | 800 | 240 | x + 5 | x | x PUCKERING |
| | | | | | UNMEASURABLE | |
| I | 350 | 800 | 220 | ∘ ± 0 | x | x POOR |
| | | | | | UNMEASURABLE | APPEARANCE |
| J | 380 | 800 | 180 | ∘ + 2 | x | x PUCKERING |
| | | | | | UNMEASURABLE | |

### Work Effects

By setting the average current IA to a high-current region of 250 A or more and setting the base current IB to 200 A or more and the peak current IP to 600 A or less, the penetration depth (penetration amount) U can be increased while suppressing welding defects.

Using 100% argon as the shielding gas S allows the arc A to be compressed to thus increase concentration of the arc A, and therefore, is advantageous in further increasing the penetration depth U.

When the arc length L is long, a shielding property of the shielding gas S is deteriorated, outside air is draw-n into the arc A, and a welding defect, such as puckering or the like, occurs. Conversely, when the arc length L is short, an occurrence frequency of a short circuit increases and the molten pool is vibrated due to an arc reignition caused by a high current during short circuit release, thus resulting in a welding defect, such as smut or the like.

By maintaining the arc length L within ±2 mm with respect to the surface Wa of the workpiece W, drawing of outside air into the arc A due to the deterioration of the shielding property achieved by the shielding gas S can be suppressed, vibration of the molten pool can be suppressed, and as a result, an advantage in suppressing a welding defect, such as puckering, smut, or the like, can be achieved.

As has been described above, for arc welding, even when 100% argon is used as the shielding gas S, deep penetration can be achieved while suppressing a welding defect.

Since helium is not used as the shielding gas S, a cost advantage can be provided.

In this embodiment, the average current IA is maintained constant at a predetermined value, the base current IB and peak current IP are maintained within a predetermined range, and furthermore, the base current IB and peak current IP (the welding current I) are caused to belong to the region sandwiched by the first straight line L1 and the second straight line L2 (that represent the relationship between the base current IB and the peak current IP). Thus, suppression of a welding defect and deep penetration can be both achieved more preferably.

### Other Embodiments

The present disclosure has been described above with reference to a preferred embodiment, but such description is not limiting the present disclosure, and as a matter of course, various modifications, substitutions, or combinations can be made to the embodiment.

### INDUSTRIAL APPLICABILITY

The present disclosure is highly useful and has high industrial applicability since it can be applied to an arc welding method and an arc welding apparatus.

DESCRIPTION OF REFERENCE CHARACTERS

| | |
|---|---|
| 1 | Arc welding apparatus |
| 13 | Welding wire (electrode) |
| 13a | Tip end |
| A | Arc |
| S | Shielding gas |
| W | Workpiece (object to be welded) |
| Wa | Surface |
| L | Arc length |
| U | Penetration depth |
| I | Welding current |
| IA | Average current |
| IB | Base current |
| IP | Peak current |
| T | Cycle |
| L1 | First straight line |
| L2 | Second straight line |

What is claimed is:

1. An arc welding method of a consumable electrode type in which welding is performed while supplying a welding current between an object to be welded and an electrode that is a welding wire to generate an arc and supplying a shielding gas around the arc,
wherein
an arc length represented by a relative position of a tip end of the electrode with respect to a surface of the object to be welded is within ±2 mm,
the shielding gas is constituted of 100% argon,
the welding current is constituted of a pulse wave in which a base current and a peak current are periodically and alternately repeated,
an average current per cycle of the welding current is 250 A or more,
the base current is 200 A or more, and
the peak current is 600 A or less.

2. The arc welding method of claim 1, wherein
the base current is 200 A or more and 300 A or less, and
the peak current is 300 A or more and 500 A or less.

3. The arc welding method of claim 1, wherein
the base current is 200 A or more and 400 A or less, and
the peak current is 400 A or more and 600 A or less.

4. The arc welding method of claim 1, wherein
the base current is 400 A or more and 500 A or less, and
the peak current is 500 A or more and 600 A or less.

5. The arc welding method of claim 1, wherein
when IB as the base current is plotted on one axis of an orthogonal coordinate system and IP as the peak current is plotted on the other axis of the orthogonal coordinate system, IB as the base current and IP as the peak current belong to a region sandwiched between a first straight line and a second straight line that represent a relationship between the IB as the base current and IP as the peak current.

6. The arc welding method of claim 1, wherein
the average current is constant.

7. The arc welding method of claim 5, wherein
the base current is 220 A or more and 300 A or less and the peak current is 300 A or more and 500 A or less,
the first straight line is represented by IP=−0.75×IB+525, and
the second straight line is represented by IP=−2.5×IB+1050.

8. The arc welding method of claim 2, wherein
the average current is 300 A.

9. The arc welding method of claim 5, wherein
the base current is 200 A or more and 400 A or less,
the peak current is 400 A or more and 600 A or less,
the first straight line is represented by IP=−IB+800, and
the second straight line is represented by IP=−2×IB+1200.

10. The arc welding method of claim 3, wherein
the average current is 400 A.

11. The arc welding method of claim 5, wherein
the base current is 400 A or more and 500 A or less,
the peak current is 500 A or more and 600 A or less,
the first straight line is represented by IP=−IB+1000, and
the second straight line is represented by IP=−5×IB+3000.

12. The arc welding method of claim 4, wherein
the average current is 500 A.

13. The arc welding method of claim 7, wherein
the average current is 300 A.

14. The arc welding method of claim 9, wherein
the average current is 400 A.

15. The arc welding method of claim 11, wherein
the average current is 500 A.

16. An arc welding apparatus of a consumable electrode type that performs welding while supplying a welding current between an object to be welded and an electrode that is a welding wire to generate an arc and supplying a shielding gas around the arc,
wherein
an arc length represented by a relative position of a tip end of the electrode with respect to a surface of the object to be welded is within ±2 mm,
the shielding gas is constituted of 100% argon,
the welding current is constituted of a pulse wave in which a base current and a peak current are periodically and alternately repeated,
an average current per cycle of the welding current is 250 A or more,
the base current is 200 A or more, and
the peak current is 600 A or less.
